(19) United States
(12) Patent Application Publication
(10) Pub. No.: US 2012/0293918 A1
(43) Pub. Date: Nov. 22, 2012

(54) SOLID ELECTROLYTIC CAPACITOR AND METHOD OF MANUFACTURING THE SAME

(75) Inventors: Takaaki Uchiyama, Katano-shi (JP); Masatomo Bando, Higashiosaka-shi (JP); Kazuyoshi Murata, Neyagawa-shi (JP)

(73) Assignee: SANYO ELECTRIC CO., LTD., Osaka (JP)

(21) Appl. No.: 13/472,692

(22) Filed: May 16, 2012

(30) Foreign Application Priority Data
May 16, 2011 (JP) 2011-109007

(51) Int. Cl. H01G 9/04; H01G 9/00

(52) U.S. Cl. 361/528; 29/25.03

(57) ABSTRACT

A solid electrolytic capacitor includes an anode body, an anode extraction layer, a dielectric layer, a first electrolyte layer, an electrical insulator, and a cathode layer. The anode extraction layer is formed on the outer circumference of the anode body. The dielectric layer is formed on a region in the outer circumference of the anode body different from a region on which the anode extraction layer is formed. The first electrolyte layer is formed on the dielectric layer. The electrical insulator is placed between the anode extraction layer and the first electrolyte layer. The cathode layer is formed on the first electrolyte layer, and is spaced apart from the anode extraction layer.

### INCORPORATION BY REFERENCE

Japanese patent application Number 2011-109007, upon which this patent application is based, is hereby incorporated by reference.

### BACKGROUND OF THE INVENTION

1. Field of the Invention

The invention relates to a solid electrolytic capacitor and a method of manufacturing the solid electrolytic capacitor.

2. Description of Related Art

FIG. 15 is a sectional view of a conventional solid electrolytic capacitor. As shown in FIG. 15, the conventional solid electrolytic capacitor includes a lead-type capacitor element 81, an outer package member 82 covering the capacitor element 81, an anode terminal 83, and a cathode terminal 84. The capacitor element 81 includes an anode body 811, an anode lead 812 implanted in the anode body 811, a dielectric layer 813 formed on the outer circumference of the anode body 811, an electrolyte layer 814 formed on the dielectric layer 813, and a cathode layer 815 formed on the electrolyte layer 814. The anode and cathode terminals 83 and 84 are spaced apart from each other in a predetermined direction 89 (horizontal direction in the plane of FIG. 15). Part of a surface of the anode terminal 83 and part of a surface of the cathode terminal 84 are exposed at a lower surface 82a of the outer package member 82. These exposed surfaces form an anode terminal surface 830 and a cathode terminal surface 840 of the solid electrolytic capacitor respectively.

The capacitor element 81 is placed on the anode and cathode terminals 83 and 84 in such a posture that a pulled-out portion 812a of the anode lead 812 is pointed in the direction 89. The pulled-out portion 812a and the anode terminal 83 are electrically connected to each other through a conductive pillow member 85. Further, the cathode layer 815 and the cathode terminal 84 are electrically connected to each other through a conductive adhesive agent (not shown in the drawings) provided therebetween.

In the conventional solid electrolytic capacitor, the anode body 811 forms an anode electrode of the solid electrolytic capacitor, and the electrolyte layer 814 and the cathode layer 815 form a cathode electrode of the solid electrolytic capacitor. The anode electrode is pulled out of the capacitor element 81 through the anode lead 812. This places limitations on reduction of the ESL (equivalent series inductance) and/or the ESR (equivalent series resistance) of the conventional solid electrolytic capacitor for the reason as follows. The anode lead 812 is composed of a thin metal wire, making it hard to reduce the inductance and the resistance of the anode lead 812.

Limitations are also placed on cost reduction of the conventional solid electrolytic capacitor for the reason as follows. The anode lead 812 is made of an expensive metallic material such as tantalum (Ta), and the anode lead 812 complicates manufacture of the solid electrolytic capacitor.

### SUMMARY OF THE INVENTION

A solid electrolytic capacitor of the invention includes an anode body, an anode extraction layer, a dielectric layer, a first electrolyte layer, an electrical insulator, and a cathode layer. The anode extraction layer is formed on the outer circumference of the anode body. The dielectric layer is formed on a region in the outer circumference of the anode body different from a region on which the anode extraction layer is formed. The first electrolyte layer is formed on the dielectric layer. The electrical insulator is placed between the anode extraction layer and the first electrolyte layer. The cathode layer is formed on the first electrolyte layer, and is spaced apart from the anode extraction layer.

A method of manufacturing a solid electrolytic capacitor of the invention includes steps (a) to (f). In the step (a), a dielectric layer is formed on the outer circumference of an anode body. In the step (b), a through hole is formed in the dielectric layer so as to penetrate the dielectric layer from the outer circumference to the inner circumference of the dielectric layer. The step (c) is performed after the step (b). In the step (c), a base layer mainly containing a solid electrolyte is formed on the outer circumference of the dielectric layer and on an exposed surface of the anode body. The exposed surface is part of the outer circumference of the anode body and is defined as a result of formation of the through hole. In the step (d), an electrical insulator is formed by performing process on part of the base layer. More specifically, the electrical insulator is formed such that the base layer becomes first and second electrolyte layers electrically insulated from each other through the electrical insulator, and that the second electrolyte layer is electrically connected to the anode body through the inside of the through hole. In the step (e), a cathode layer is formed on the first electrolyte layer. In the step (f), an anode layer is formed on the second electrolyte layer.

Another method of manufacturing a solid electrolytic capacitor of the invention includes the steps (i) to (n). In the step (i), a dielectric layer is formed on the outer circumference of an anode body. In the step (j), a base layer mainly containing an electrolyte is formed on the outer circumference of the dielectric layer. In the step (k), a through hole is formed in the dielectric layer and the base layer so as to penetrate the dielectric layer and the base layer from the outer circumference of the base layer to the inner circumference of the dielectric layer. In the step (l), the electrolyte is changed to an electrical insulating material at an edge portion of the base layer by being heated. The edge portion is defined as a result of formation of the through hole. In the step (m), an anode extraction layer is formed on an exposed surface of the anode body. The exposed surface is part of the outer circumference of the anode body and is defined as a result of formation of the through hole. In the step (n), a cathode layer is formed on a region in the outer circumference of the base layer and spaced apart from a region where the through hole is formed.

### BRIEF DESCRIPTION OF THE DRAWINGS

FIG. 1 is a perspective view of a solid electrolytic capacitor of a first embodiment of the invention as viewed from the lower surface thereof;

FIG. 2 is a sectional view taken along line II-II of FIG. 1;

FIG. 3 is a sectional view of a modification of the solid electrolytic capacitor of the first embodiment;

FIG. 4 is a sectional view used to explain a dielectric layer forming step performed in a method of manufacturing the solid electrolytic capacitor of the first embodiment;

FIG. 5 is a sectional view used to explain a through hole forming step performed in the method of manufacturing the solid electrolytic capacitor of the first embodiment;

FIG. 6 is a sectional view used to explain a base layer forming step performed in the method of manufacturing the solid electrolytic capacitor of the first embodiment;

FIG. 7 is a sectional view used to explain an electrode layer forming step performed in the method of manufacturing the solid electrolytic capacitor of the first embodiment;

FIG. 8 is a sectional view used to explain a recessed portion forming step performed in the method of manufacturing the solid electrolytic capacitor of the first embodiment;

FIG. 9 is a sectional view of a solid electrolytic capacitor of a second embodiment of the invention;

FIG. 10 is a sectional view used to explain an insulation forming step performed in a method of manufacturing the solid electrolytic capacitor of the second embodiment;

FIG. 11 is a sectional view of a solid electrolytic capacitor of a third embodiment of the invention;

FIG. 12 is a sectional view used to explain a base layer forming step performed in a method of manufacturing the solid electrolytic capacitor of the third embodiment;

FIG. 13 is a sectional view used to explain a through hole forming step performed in the method of manufacturing the solid electrolytic capacitor of the third embodiment;

FIG. 14 is a sectional view used to explain an insulation forming step performed in the method of manufacturing the solid electrolytic capacitor of the third embodiment; and

FIG. 15 is a sectional view of a conventional solid electrolytic capacitor.

### DETAILED DESCRIPTION OF THE EMBODIMENTS

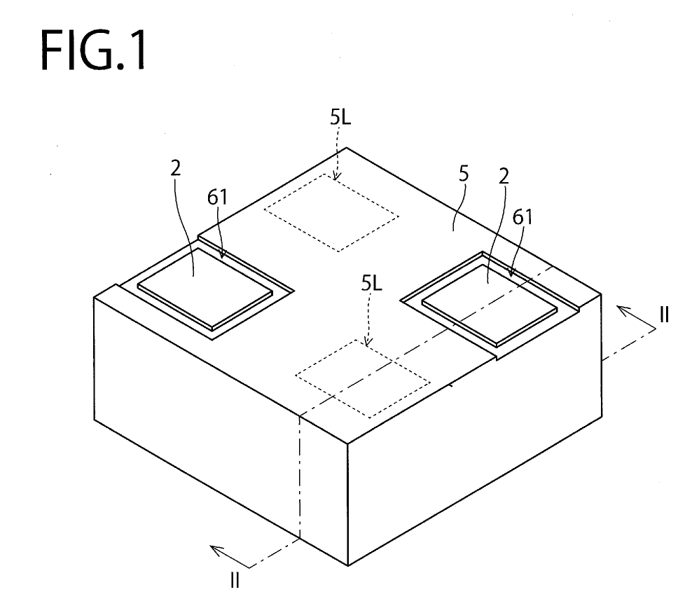

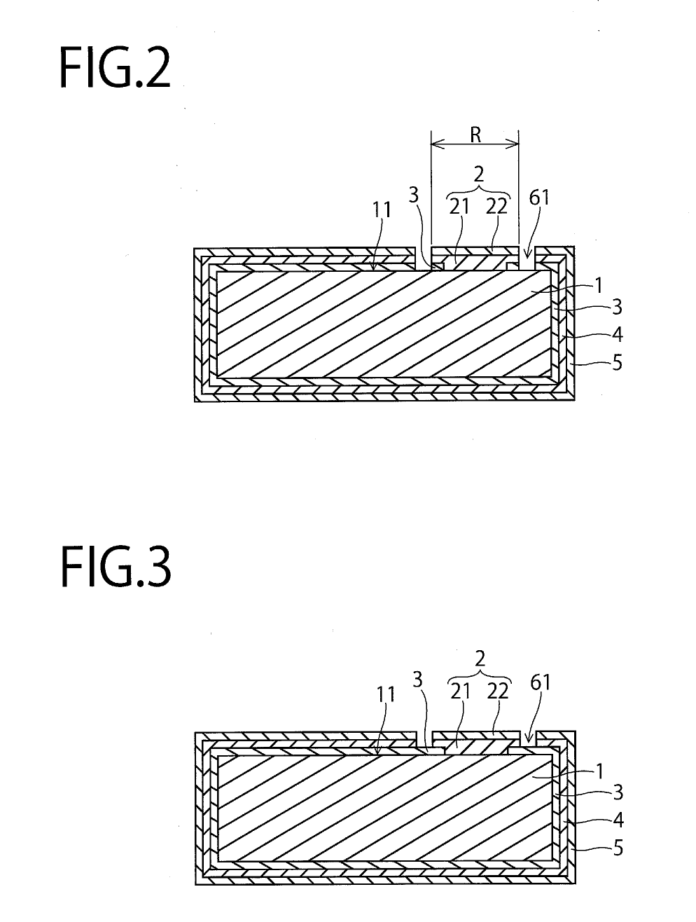

FIG. 1 is a perspective view of a solid electrolytic capacitor of a first embodiment of the invention as viewed from the lower surface thereof. FIG. 2 is a sectional view taken along line II-II of FIG. 1. As shown in FIGS. 1 and 2, the solid electrolytic capacitor of the first embodiment includes an anode body 1, anode extraction layers 2, a dielectric layer 3, a first electrolyte layer 4, a cathode layer 5, and recessed portions 61.

The anode body 1 is composed of a porous sintered body in the form of a substantially rectangular parallelepiped. The porous sintered body is made of a valve acting metal such as tantalum (Ta), niobium (Ni), titanium (Ti), and aluminum (Al).

The anode extraction layers 2 are formed on corresponding predetermined regions R defined at a plurality of places in a first surface 11 of the anode body 1. The first surface 11 is part of the outer circumference of the anode body 1 and becomes a lower surface of the anode body 1 when the solid electrolytic capacitor is used in a normal condition. The solid electrolytic capacitor of the first embodiment has an array structure where two anode extraction layers 2 are arranged on the first surface 11 of the anode body 1 (see FIG. 1). Further, a surface of each of the anode extraction layers 2 is substantially in the same plane with the outer circumference of the cathode layer 5 described later (see FIG. 2).

The anode extraction layers 2 have conductivity, and are electrically connected to the anode body 1. More specifically, the anode extraction layers 2 are each composed of a second electrolyte layer 21 formed on a corresponding predetermined region R, and an anode layer 22 formed on the second electrolyte layer 21. The anode extraction layers 2 may each include part of the dielectric layer 3 as shown in FIG. 2.

The second electrolyte layer 21 mainly contains a solid electrolyte. A conductive inorganic material such as manganese dioxide, or a conductive organic material such as TCNQ (tetracyano-quinodimethane) complex salt and conductive polymer is used as the solid electrolyte. The anode layer 22 is composed of a carbon layer (not shown in the drawings) formed on the second electrolyte layer 21, and a silver paint layer (not shown in the drawings) formed on the carbon layer. The anode layer 22 may be composed of a plated layer having conductivity.

The dielectric layer 3 is formed on a region in the outer circumference of the anode body 1 different from regions on which the anode extraction layers 2 are formed. The dielectric layer 3 is composed of an oxide coating film formed by oxidizing the outer circumference of the anode body 1.

The first electrolyte layer 4 is formed on the dielectric layer 3. Like the second electrolyte layer 21, the first electrolyte layer 4 mainly contains a solid electrolyte. The cathode layer 5 is formed on the first electrolyte layer 4. More specifically, the cathode layer 5 is composed of a carbon layer (not shown in the drawings) formed on the first electrolyte layer 4, and a silver paint layer (not shown in the drawings) formed on the carbon layer. The cathode layer 5 may be composed of a plated layer having conductivity.

As shown in FIGS. 1 and 2, the recessed portions 61 are provided in one-to-one correspondence with the anode extraction layers 2. The recessed portions 61 are each provided between a corresponding anode extraction layer 2 and the cathode layer 5. More specifically, the recessed portions 61 are each formed around a corresponding anode extraction layer 2 so as to surround the corresponding anode extraction layer 2. The recessed portions 61 each have a bottom surface reaching a depth corresponding to the level of the first surface 11 (outer circumference) of the anode body 1 (see FIG. 2). So, each of the recessed portions 61 is placed between an anode extraction layer 2 corresponding to this recessed portion 61 and the cathode layer 5, and spaces this anode extraction layer 2 and the cathode layer 5 apart from each other. Further, each of the recessed portions 61 is also placed between an anode extraction layer 2 corresponding to this recessed portion 61 and the first electrolyte layer 4, and electrically insulates this anode extraction layer 2 and the first electrolyte layer 4 from each other. Thus, the recessed portions 61 each function as an electrical insulator provided between an anode extraction layer 2 corresponding to this recessed portion 61 and the first electrolyte layer 4.

The solid electrolytic capacitor of the first embodiment is implemented on a circuit board, for example. For the implementation, the anode extraction layers 2 are electrically connected to anode lands provided on the circuit board. Further, predetermined regions (cathode land connection regions) 5L (see FIG. 1) are connected to cathode lands provided on the circuit board. The predetermined regions 5L are in a surface being part of the outer circumference of the cathode layer 5 and to become the lower surface of the cathode layer 5 when the solid electrolytic capacitor is used in a normal condition.

FIG. 3 is a sectional view of a modification of the solid electrolytic capacitor of the first embodiment. As shown in FIG. 3, the recessed portions 61 may each have a bottom surface reaching a depth corresponding to the level of the outer circumference of the dielectric layer 3. Like the structure shown in FIG. 2, the structure of FIG. 3 causes the recessed portions 61 to electrically insulate the anode extraction layers 2 and the first electrolyte layer 4 from each other.

A method of manufacturing the solid electrolytic capacitor of the first embodiment is described next. The manufacturing method includes a dielectric layer forming step, a through hole forming step, a base layer forming step, an electrode layer forming step, and a recessed portion forming step performed in this order.

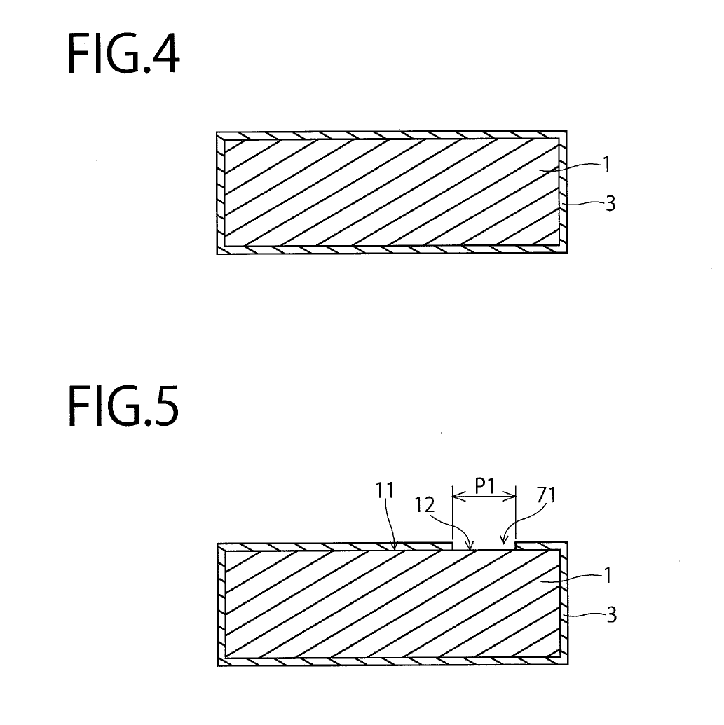

FIG. 4 is a sectional view used to explain the dielectric layer forming step. As shown in FIG. 4, in the dielectric layer forming step, chemical conversion process is performed on the anode body 1 to form the dielectric layer 3 on the outer circumference of the anode body 1. More specifically, the anode body 1 is dipped into a chemical conversion solution, and an external electrode is brought into electrical contact with the anode body 1. In this condition, a voltage is applied between the external electrode and the chemical conversion solution to electrochemically oxidize the outer circumference of the anode body 1. As a result, an oxide coating film is formed on the outer circumference of the anode body 1, and the oxide coating film thereby formed becomes the dielectric layer 3. A solution such as a phosphorus acid solution and an adipic acid solution is used as the chemical conversion solution.

FIG. 5 is a sectional view used to explain the through hole forming step. As shown in FIG. 5, in the through hole forming step, process such as laser stripping is performed on the dielectric layer 3 to form a through hole 71 at a predetermined position P1 in the dielectric layer 3. The through hole 71 penetrates the dielectric layer 3 from the outer circumference to the inner circumference of the dielectric layer 3. The predetermined position P1 is defined at a plurality of places at which the anode extraction layers 2 are to be formed.

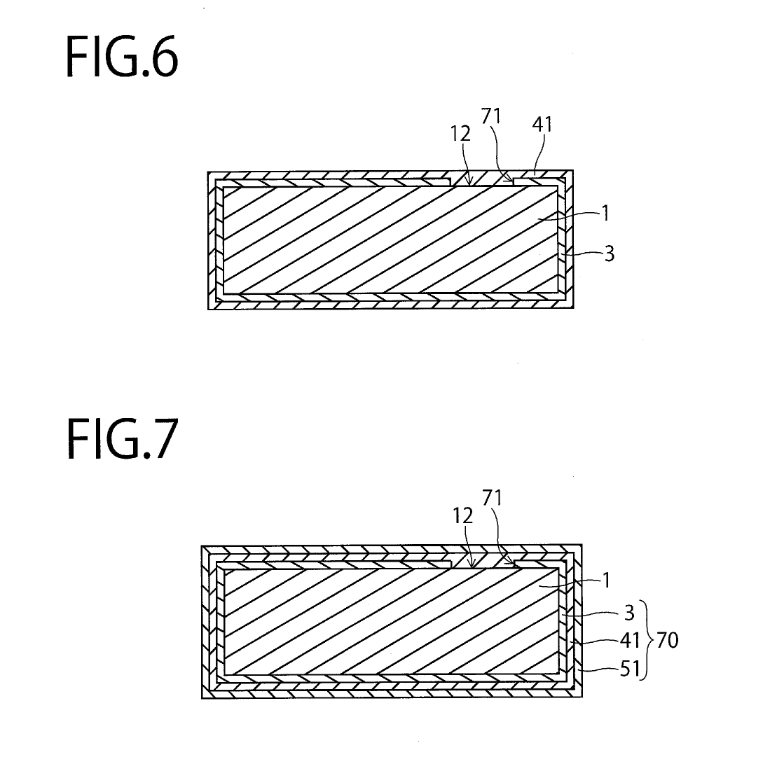

FIG. 6 is a sectional view used to explain the base layer forming step. As shown in FIG. 6, in the base layer forming step, a base layer 41 mainly containing a solid electrolyte is formed by electropolymerization or chemical polymerization on the outer circumference of the dielectric layer 3 and on an exposed surface 12 (see FIG. 5) of the anode body 1. The exposed surface 12 is part of the outer circumference of the anode body 1 and is defined as a result of formation of each through hole 71. More specifically, the anode body 1 is dipped into a polymerization solution, and then the polymerization solution is electrically or chemically polymerized. As a result, a polymerized film is formed on the outer circumference of the dielectric layer 3 and on the exposed surfaces 12 of the anode body 1, and the polymerized film thereby formed becomes the base layer 41. The base layer 41 is electrically connected to the anode body 1 through the inside of each of the through holes 71.

FIG. 7 is a sectional view used to explain the electrode layer forming step. As shown in FIG. 7, in the electrode layer forming step, an electrode layer 51 is formed on the outer circumference of the base layer 41. More specifically, the anode body 1 is first dipped in a carbon paste to form a carbon layer (not shown in the drawings) on the outer circumference of the base layer 41. Next, the anode body 1 is dipped in a silver paste to form a silver paint layer (not shown in the drawings) on the carbon layer. Plating process may be performed on the outer circumference of the base layer 41 to form a plated layer to become the electrode layer 51. As a result, the dielectric layer 3, the base layer 41, and the electrode layer 51 are formed over the outer circumference of the anode body 1 at a time when the electrode layer forming step is finished. These layers form a multilayered film 70.

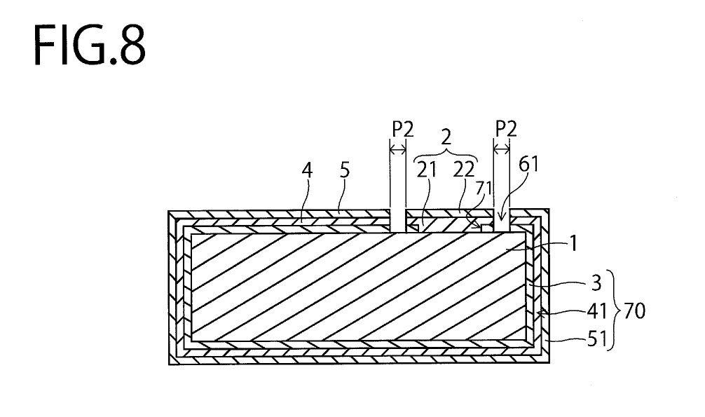

FIG. 8 is a sectional view used to explain the recessed portion forming step. As shown in FIG. 8, in the recessed portion forming step, process such as pattern etching is performed on the multilayered film 70 to form the recessed portion 61 at a predetermined position P2 in the multilayered film 70. The recessed portion 61 penetrates at least the electrode layer 51 and the base layer 41. The predetermined position P2 is defined around part of the multilayered film 70 to become the anode extraction layer 2 (namely, part where the through hole 71 is formed) so as to surround this part. In the first embodiment, the part to become the anode extraction layer 2 is defined at a plurality of places in the multilayered film 70, and the predetermined position P2 is defined around each of these parts. The recessed portions 61 each penetrate the electrode layer 51 and the base layer 41 and additionally, penetrate the dielectric layer 3. Thus, the bottom surface of each of the recessed portions 61 reaches a depth corresponding to the level of the first surface 11 (outer circumference) of the anode body 1.

As a result of execution of the recessed portion forming step, the anode extraction layer 2 is formed inside the place where each of the recessed portions 61 is formed. The base layer 41 becomes the first electrolyte layer 4 and the second electrolyte layers 21. The first electrolyte layer 4 is in a region outside the place where each of the recessed portions 61 is formed, and each of the second electrolyte layers 21 is in a region inside the place where a corresponding recessed portion 61 is formed. This spaces the first electrolyte layer 4 and the second electrolyte layers 21 apart from each other. To be specific, the first electrolyte layer 4 and the second electrolyte layers 21 are electrically insulated from each other through the recessed portions 61. Further, the second electrolyte layers 21 are each electrically connected to the anode body 1 through the inside of a corresponding through hole 71. Meanwhile, the electrode layer 51 becomes the cathode layer 5 and the anode layers 22. The cathode layer 5 is in the region outside the place where each of the recessed portions 61 is formed, and each of the anode layers 22 is in the region inside the place where a corresponding recessed portion 61 is formed. This spaces the cathode layer 5 and the anode layers 22 apart from each other. Further, the cathode layer 5 is formed on the first electrolyte layer 4, and the anode layers 22 are formed on corresponding second electrolyte layers 21.

As a result, formation of the solid electrolytic capacitor shown in FIGS. 1 and 2 is completed. In the recessed portion forming step, each of the recessed portions 61 may also be formed such that the recessed portion 61 penetrates the electrode layer 51 and the base layer 41 but does not penetrate the dielectric layer 3 (see FIG. 3).

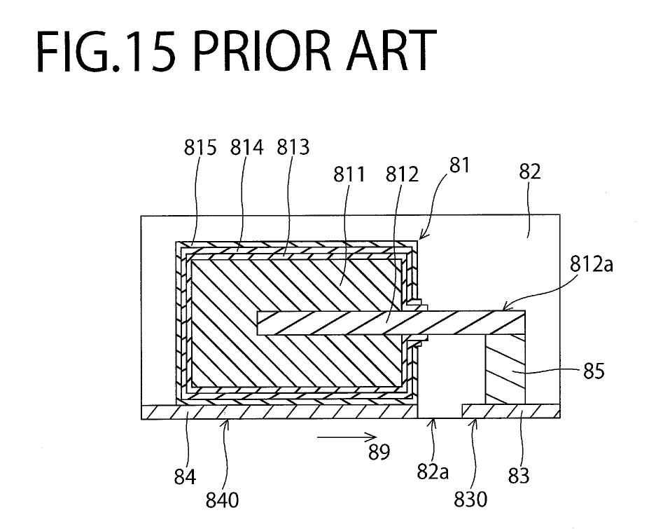

In the solid electrolytic capacitor of the first embodiment, the anode body 1 forms an anode electrode of the solid electrolytic capacitor, and the first electrolyte layer 4 and the cathode layer 5 form a cathode electrode of the solid electrolytic capacitor. The anode electrode is pulled out through the anode extraction layers 2 to the lower surface (outer circumference) of the solid electrolytic capacitor. Further, the recessed portions 61 prevents the anode extraction layers 2 from being short circuited with the cathode electrode. Thus, the anode electrode can be pulled out without the need of using an anode lead. The anode extraction layers 2 each have an inductance and a resistance considerably lower than those of an anode lead. This makes the ESL and/or ESR of the solid electrolytic capacitor of the first embodiment lower than the ESL and/or ESR of the conventional solid electrolytic capacitor (see FIG. 15), thereby achieving reduction of the ESL and/or ESR of the solid electrolytic capacitor.

Also, in the solid electrolytic capacitor of the first embodiment, the anode extraction layers 2 are formed of an inexpensive conductive material. Further, eliminating the need of using an anode lead simplifies manufacture of the solid electrolytic capacitor compared to that of the conventional solid electrolytic capacitor (see FIG. 15). Thus, the solid electrolytic capacitor of the first embodiment involves lower manufacturing costs than the conventional solid electrolytic capacitor, thereby achieving cost reduction of the solid electrolytic capacitor.

In addition, the solid electrolytic capacitor of the first embodiment has an array structure where the two anode extraction layers 2 are arranged on the first surface 11 of the anode body 1. Further, the anode extraction layers 2 are each surrounded by the cathode layer 5. Thus, magnetic fields easily cancel each other out that are generated by currents caused to flow in the anode extraction layers 2 and the cathode layer 5 in response to application of a voltage between the anode extraction layers 2 and the cathode layer 5. To be specific, current canceling effect is achieved easily in the solid electrolytic capacitor. So, the solid electrolytic capacitor of the first embodiment is likely to achieve further reduction of ESL.

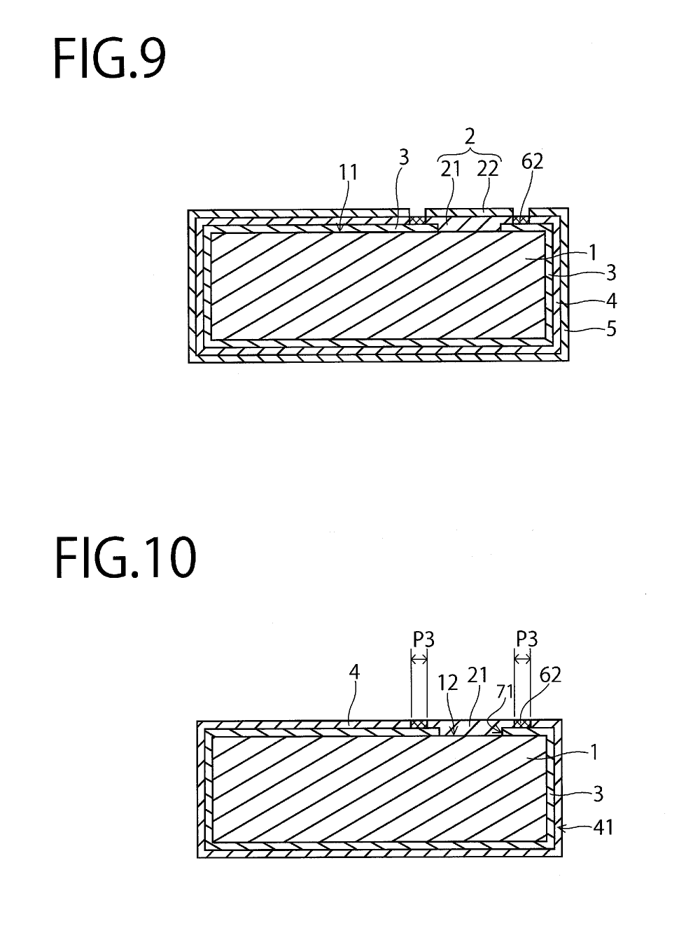

FIG. 9 is a sectional view of a solid electrolytic capacitor of a second embodiment of the invention. The solid electrolytic capacitor of the second embodiment includes an anode body 1, anode extraction layers 2, a dielectric layer 3, a first electrolyte layer 4, and a cathode layer 5 (see FIG. 9). These components are the same as those of the solid electrolytic capacitor shown in FIG. 3. Meanwhile, the solid electrolytic capacitor of the second embodiment includes electrical insulators 62 in place of the recessed portions 61 of the solid electrolytic capacitor shown in FIG. 3. The electrical insulators 62 are formed by changing a solid electrolyte to an electrical insulating material. The electrical insulators 62 are provided in one-to-one correspondence with the anode extraction layers 2. The electrical insulators 62 are each provided between a corresponding anode extraction layer 2 and the first electrolyte layer 4. More specifically, the electrical insulators 62 are each formed around a corresponding anode extraction layer 2 so as to surround the corresponding anode extraction layer 2. This places each of the electrical insulators 62 between an anode extraction layer 2 corresponding to this electrical insulator 62 and the first electrolyte layer 4.

A method of manufacturing the solid electrolytic capacitor of the second embodiment is described next. The manufacturing method of the second embodiment includes a dielectric layer forming step, a through hole forming step, and a base layer forming step performed in this order and in the same manner as in the manufacturing method of the first embodiment. The manufacturing method of the second embodiment further includes an insulation forming step and an electrode layer forming step performed in this order after the base layer forming step.

FIG. 10 is a sectional view used to explain the insulation forming step. As shown in FIG. 10, in the insulation forming step, process such as laser irradiation is performed to heat a predetermined position P3 in a base layer 41 to change a solid electrolyte to an electrical insulating material at the predetermined position P3. The predetermined position P3 is defined around part of the base layer 41 to become a second electrolyte layer 21 so as to surround this part. In the second embodiment, the part to become the second electrolyte layer 21 is defined at a plurality of places in the base layer 41, and the predetermined position P3 is defined around each of these parts.

Polypyrrole being a conductive polymer is used as the solid electrolyte, for example. Polypyrrole changes to an electrical insulating material by being heated at a temperature of from 300 to 400 degrees.

As a result of execution of the insulation forming step, the electrical insulators 62 are each formed at a corresponding predetermined position P3 in the base layer 41. The base layer 41 becomes the first electrolyte layer 4 and the second electrolyte layers 21. The first electrolyte layer 4 is in a region outside the place where each of the electrical insulators 62 is formed, and each of the second electrolyte layers 21 is in a region inside the place where a corresponding electrical insulator 62 is formed. This spaces the first electrolyte layer 4 and the second electrolyte layers 21 apart from each other. To be specific, the first electrolyte layer 4 and the second electrolyte layers 21 are electrically insulated from each other through the electrical insulators 62. Further, the second electrolyte layers 21 are each electrically connected to the anode body 1 through the inside of a corresponding through hole 71.

As shown in FIG. 9, in the electrode layer forming step, the cathode layer 5 is formed on the first electrolyte layer 4, and anode layers 22 are formed on corresponding second electrolyte layers 21. More specifically, a carbon layer is first selectively formed by using process such as printing on the first electrolyte layer 4 and the second electrolyte layers 21. Next, a silver paint layer is selectively formed by using process such as printing on the carbon layer. As a result, formation of the solid electrolytic capacitor shown in FIG. 9 is completed. Plating process may be performed selectively on the outer circumferences of the first electrolyte layer 4 and the second electrolyte layers 21 to form a plated layer to become the cathode layer 5 and the anode layers 22. The anode layers 22 may be formed simultaneously with formation of the cathode layer 5, or in a step different from formation of the cathode layer 5.

Like in the solid electrolytic capacitor of the first embodiment, the ESL and/or ESR of the solid electrolytic capacitor of the second embodiment are lower than the ESL and/or ESR of the conventional solid electrolytic capacitor, thereby achieving reduction of the ESL and/or ESR of the solid electrolytic capacitor. Further, the solid electrolytic capacitor of the second embodiment involves lower manufacturing costs than the conventional solid electrolytic capacitor, thereby achieving cost reduction of the solid electrolytic capacitor.

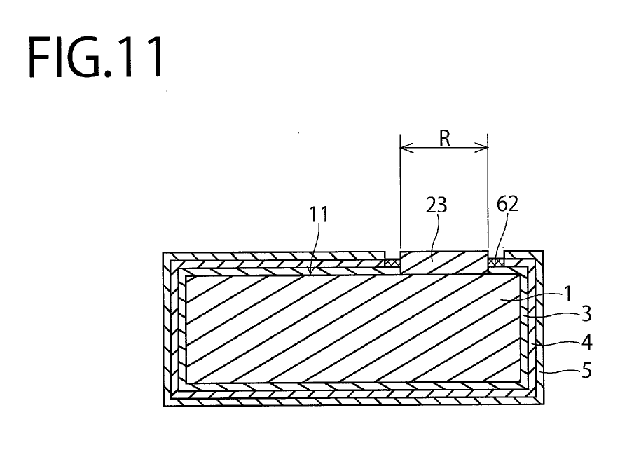

FIG. 11 is a sectional view of a solid electrolytic capacitor of a third embodiment of the invention. The solid electrolytic capacitor of the third embodiment includes an anode body 1, anode extraction layers 23, a dielectric layer 3, a first electrolyte layer 4, a cathode layer 5, and electrical insulators 62 (see FIG. 11). These components except the anode extraction layers 23 are the same as those of the solid electrolytic capacitor of the second embodiment (see FIG. 9).

Like the anode extraction layers 2 of the solid electrolytic capacitor of the first embodiment (see FIG. 2), the anode extraction layers 23 are formed on corresponding predetermined regions R in a first surface 11 of the anode body 1. The anode extraction layers 23 are each composed of a carbon layer (not shown in the drawings) formed on a corresponding predetermined region R, and a silver paint layer (not shown in the drawings) formed on the carbon layer. The anode extraction layers 23 may each be composed of a plated layer having conductivity.

A method of manufacturing the solid electrolytic capacitor of the third embodiment is described next. The manufacturing method includes a dielectric layer forming step, a base layer forming step, a through hole forming step, an insulation forming step, and an electrode layer forming step performed in this order. The dielectric layer forming step is performed in the same manner as the dielectric layer forming step of the manufacturing method of the first embodiment.

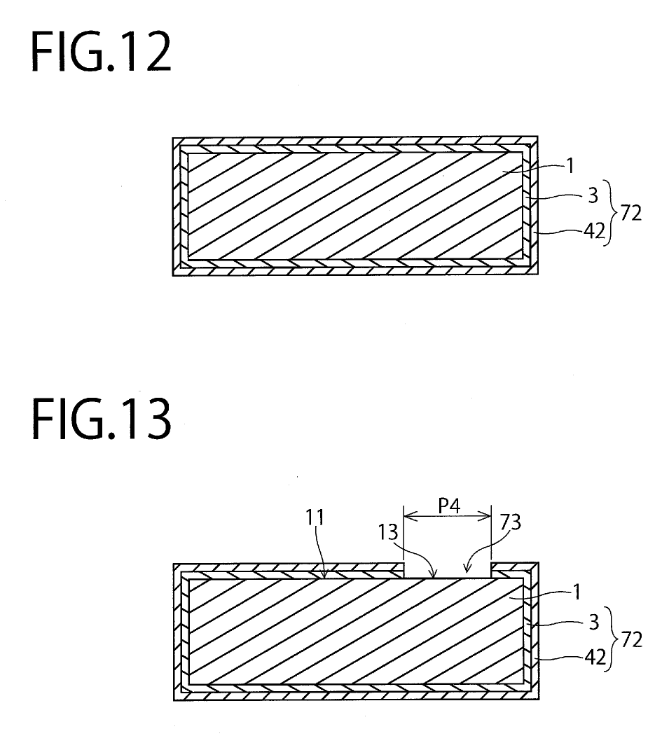

FIG. 12 is a sectional view used to explain the base layer forming step. As shown in FIG. 12, in the base layer forming step, a base layer 42 mainly containing a solid electrolyte is formed by electropolymerization or chemical polymerization on the outer circumference of the dielectric layer 3. More specifically, the anode body 1 is dipped into a polymerization solution, and then the polymerization solution is electrically or chemically polymerized. As a result, a polymerized film is formed on the outer circumference of the dielectric layer 3 and the polymerized film thereby formed becomes the base layer 42. The dielectric layer 3 and the base layer 42 are formed over the outer circumference of the anode body 1 at a time when the base layer forming step is finished, and these layers form a multilayered film 72.

FIG. 13 is a sectional view used to explain the through hole forming step. As shown in FIG. 13, in the through hole forming step, process such as laser stripping is performed on the multilayered film 72 to form a through hole 73 at a predetermined position P4 in the multilayered film 72. The through hole 73 penetrates the multilayered film 72 from the outer circumference of the base layer 42 to the inner circumference of the dielectric layer 3. The predetermined position P4 is defined at a plurality of places at which the anode extraction layers 23 are to be formed.

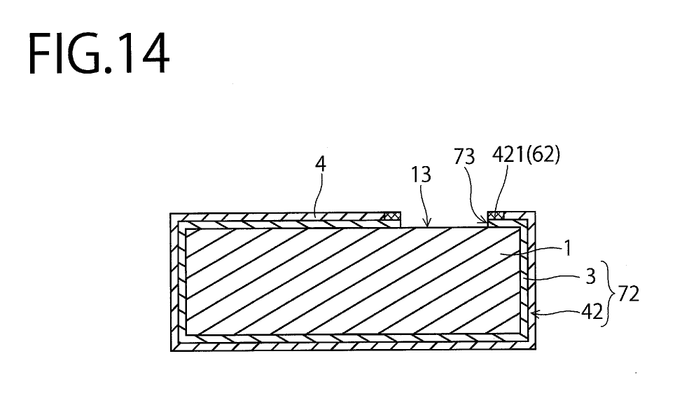

FIG. 14 is a sectional view used to explain the insulation forming step. As shown in FIG. 14, in the insulation forming step, process such as laser irradiation is performed to heat edge portions 421 of the base layer 42 defined as a result of formation of corresponding through holes 73. Each of the edge portions 421 is heated entirely in a region around a corresponding through hole 73. As a result, a solid electrolyte changes to an electrical insulating material at the edge portions 421. Polypyrrole being a conductive polymer is used as the solid electrolyte, for example. Polypyrrole changes to an electrical insulating material by being heated at a temperature of from 300 to 400 degrees.

As a result of execution of the insulation forming step, the edge portions 421 of the base layer 42 become the electrical insulators 62, and part of the base layer 42 different from the edge portions 421 becomes the first electrolyte layer 4. If a laser beam is applied to form the through holes 73, the edge portions 421 of the base layer 42 are heated simultaneously with formation of the through holes 73. So, the through hole forming step and the insulation forming step may be performed simultaneously by using a laser beam.

As shown in FIG. 11, in the electrode layer forming step, the anode extraction layer 23 is formed on an exposed surface 13 (see FIG. 14) of the anode body 1. The exposed surface 13 is part of the outer circumference of the anode body 1 and is defined as a result of formation of each through hole 73. In the electrode layer forming step, the cathode layer 5 is also formed on a region in the outer circumference of the base layer 42 and spaced apart from the regions where the through holes 73 are formed. In the third embodiment, the cathode layer 5 is formed on the first electrolyte layer 4.

More specifically, a carbon layer is first selectively formed by using process such as printing on the exposed surfaces 13 of the anode body 1 and the first electrolyte layer 4. Next, a silver paint layer is selectively formed by using process such as printing on the carbon layer. As a result, formation of the solid electrolytic capacitor shown in FIG. 11 is completed. A plated layer to become the anode extraction layers 23 and the cathode layer 5 may be formed by performing plating process selectively on the exposed surfaces 13 of the anode body 1 and the outer circumference of the first electrolyte layer 4. The anode extraction layers 23 may be formed simultaneously with formation of the cathode layer 5, or in a step different from formation of the cathode layer 5.

Like in the solid electrolytic capacitor of the first embodiment, the ESL and/or ESR of the solid electrolytic capacitor of the third embodiment are lower than the ESL and/or ESR of the conventional solid electrolytic capacitor, thereby achieving reduction of the ESL and/or ESR of the solid electrolytic capacitor. Further, the solid electrolytic capacitor of the third embodiment involves lower manufacturing costs than the conventional solid electrolytic capacitor, thereby achieving cost reduction of the solid electrolytic capacitor.

The structure of each part of the invention is not limited to that shown in the embodiments described above. Various modifications can be devised without departing from the technical scope recited in claims. By way of example, in the solid electrolytic capacitor of each of the embodiments, the anode extraction layer 2 or 23 may be provided at one place, or at a plurality of places not limited to two on the outer circumference of the anode body 1. Further, the anode extraction layer 2 or 23 may be formed on part of the outer circumference of the anode body 1 to become the upper or side surface of the anode body 1 when the solid electrolytic capacitor is used in a normal condition. Still further, the cathode land connection region 5L may be provided at one place, or at a plurality of places not limited to two on the outer circumference of the cathode layer 5. The cathode land connection region 5L may be formed on part of the outer circumference of the cathode layer 5 to become the upper or side surface of the cathode layer 5 when the solid electrolytic capacitor is used in a normal condition.

The solid electrolytic capacitor of each of the embodiments may have a structure where an anode terminal is electrically connected to the anode extraction layer 2 or 23, and a cathode terminal is electrically connected to the cathode layer 5. Compared to the conventional solid electrolytic capacitor (see FIG. 15), this structure increases the degree of flexibility in the design of the anode and cathode terminals including the positions of the anode and cathode terminals.

In the manufacturing method of the first embodiment, the recessed portions 61 may be formed (in the recessed portion forming step) at least in the base layer 41 before the electrode layer forming step. In this case, in the electrode layer forming step, the electrode layer is selectively formed on the first electrolyte layer 4 and the second electrolyte layers 21. The electrode layer on the first electrolyte layer 4 becomes the cathode layer 5, and the electrode layer on each of the second electrolyte layers 21 becomes the anode layer 22.

1. A solid electrolytic capacitor, comprising:
an anode body;
an anode extraction layer formed on the outer circumference of the anode body;
a dielectric layer formed on a region in the outer circumference of the anode body different from a region on which the anode extraction layer is formed;
a first electrolyte layer formed on the dielectric layer;
an electrical insulator placed between the anode extraction layer and the first electrolyte layer; and
a cathode layer formed on the first electrolyte layer, the cathode layer being spaced apart from the anode extraction layer.

2. The solid electrolytic capacitor according to claim 1, wherein the anode extraction layer includes
a second electrolyte layer formed on the region in the outer circumference of the anode body and on which the anode extraction layer is formed, and
an anode layer formed on the second electrolyte layer.

3. The solid electrolytic capacitor according to claim 1, wherein a recessed portion is formed between the anode extraction layer and the first electrolyte layer, the recessed portion has a bottom surface reaching at least a depth corresponding to the level of the outer circumference of the dielectric layer, and the recessed portion forms the electrical insulator.

4. A method of manufacturing a solid electrolytic capacitor, comprising the steps of:
(a) forming a dielectric layer on the outer circumference of an anode body;
(b) forming a through hole in the dielectric layer so as to penetrate the dielectric layer from the outer circumference to the inner circumference of the dielectric layer;
(c) forming a base layer mainly containing an electrolyte on the outer circumference of the dielectric layer and on an exposed surface of the anode body, the exposed surface being part of the outer circumference of the anode body and being defined as a result of formation of the through hole, the step (c) being performed after the step (b);
(d) forming an electrical insulator by performing process on part of the base layer, the electrical insulator being formed such that the base layer becomes first and second electrolyte layers electrically insulated from each other through the electrical insulator, and that the second electrolyte layer is electrically connected to the anode body through the inside of the through hole;
(e) forming a cathode layer on the first electrolyte layer; and
(f) forming an anode layer on the second electrolyte layer.

5. The method according to claim 4, performing the following steps (g) and (h) after the step (c) to realize the steps (d) to (f):
(g) forming an electrode layer on the outer circumference of the base layer; and
(h) forming a recessed portion so as to penetrate at least the electrode layer and the base layer by performing process on a multilayered film formed over the outer circumference of the anode body at a time when the step (g) is finished, the recessed portion being formed such that the electrode layer becomes the cathode and anode layers spaced apart from each other by the recessed portion, and that the base layer becomes the first and second electrolyte layers spaced apart from each other by the recessed portion, the recessed portion forming the electrical insulator.

6. A method of manufacturing a solid electrolytic capacitor, comprising the steps of:
(i) forming a dielectric layer on the outer circumference of an anode body;
(j) forming a base layer mainly containing an electrolyte on the outer circumference of the dielectric layer;
(k) forming a through hole in the dielectric layer and the base layer so as to penetrate the dielectric layer and the base layer from the outer circumference of the base layer to the inner circumference of the dielectric layer;
(l) changing the electrolyte to an electrical insulating material at an edge portion of the base layer by heating the edge portion, the edge portion being defined as a result of formation of the through hole;
(m) forming an anode extraction layer on an exposed surface of the anode body, the exposed surface being part of the outer circumference of the anode body and being defined as a result of formation of the through hole; and
(n) forming a cathode layer on a region in the outer circumference of the base layer and spaced apart from a region where the through hole is formed.
